(19) United States
(12) Patent Application Publication
(10) Pub. No.: US 2025/0283776 A1
(43) Pub. Date: Sep. 11, 2025

(54) LEAKAGE DIAGNOSIS METHOD AND LEAKAGE DIAGNOSIS SYSTEM FOR A TANK OF A VEHICLE

(71) Applicant: Thomas Magnete GmbH, Herdorf (DE)

(72) Inventors: Olaf OHLIGSCHLÄGER, Grünebach (DE); Edwin KREUZBERG, Daaden (DE); Thomas FABIG, Nauroth (DE)

(21) Appl. No.: 18/860,394

(22) PCT Filed: Apr. 24, 2023
(86) PCT No.: PCT/EP2023/060561

§ 371 Date: Oct. 25, 2024

(30) Foreign Application Priority Data
Apr. 28, 2022 (DE) 10 2022 110 333.1

(51) Int. Cl. G01M 3/32; F04B 43/02; F04B 49/22

(52) U.S. Cl. CPC G01M 3/3272; F04B 43/02; F04B 49/22; G01M 3/3209

(57) ABSTRACT

The system relates to a leakage diagnosis system and method for a tank of a vehicle, comprising at least one first connection point and a second connection point, which are each designed to be connected to the tank or to be open to an environment, at least one diaphragm pump which is designed for conveying fluid from the first connection point to the second connection point, at least one ventilation valve which is connected parallel to the diaphragm pump between the first connection point and the second connection point and which is designed to be switched into a first position in which the first connection point and the second connection point are fluidically connected, and into a second position which prevents a fluid flow at least from the second connection point to the first connection point, and at least one evaluation unit which is designed to operate the diaphragm pump, to switch the ventilation valve into the second position and to determine a pressure (curve) in the connected tank, in order to deduce the existence of a leakage in the tank from the pressure (curve). The leakage diagnosis system also has at least one safety valve which is designed to at least partially reduce a pressure difference between the first connection point and the second connection point.

### CROSS-REFERENCE TO RELATED APPLICATIONS

This application is a National Stage of International Application No. PCT/EP2023/060561, filed Apr. 24, 2023, which claims the benefit of and priority to German Patent Application DE 102022110333.1, filed Apr. 28, 2022. The entire disclosures of the above applications are incorporated by reference herein.

### FIELD

The invention relates to a leakage diagnosis system for a tank of a vehicle and a method for a leakage diagnosis for a tank of a vehicle by the leakage diagnosis system. The invention further relates to a vehicle which has a tank and the leakage diagnosis system.

### BACKGROUND

This section provides background information related to the present disclosure which is not necessarily prior art.

Current leakage diagnosis systems for leakage diagnosis are used, amongst other things, in fuel tanks of motor vehicles. A pressure difference between the tank pressure and the ambient pressure is initially created and a leakage of the tank is deduced from the time curve of the tank pressure. A vane pump is used for creating the pressure difference between the tank pressure and the ambient pressure. The vane pump is operated until a predetermined pressure has been set in the tank. As a result of the untightness of the vane pump due to the design principle, when the vane pump is at a standstill it leads to the outflow of the fluid from the tank through the vane pump. In order to prevent such an outflow, which would falsify a leakage diagnosis of the tank, the vane pump also continues to be operated during the leakage diagnosis. This leads to pressure pulsations in the tank which impede a leakage detection in the tank. The vane pump used in the prior art is also susceptible to contamination and wear due to the gap between the vane cells and the fixed housing. As the vane pump ages, the pumping capacity thereof reduces, whereby the time required for creating pressure in the connected tank increases. Vane pumps are also limited in their pumping capacity and cannot be used effectively for building up pressure in large tanks. These known leakage diagnosis systems also have the disadvantage that —in the case of a malfunction of the vane pump—excessive positive pressure can be produced in the vehicle tank by the vane pump, so that it leads to damage to the tank or to the vehicle.

### SUMMARY

This section provides a general summary of the disclosure, and is not a comprehensive disclosure of its full scope or all of its features.

It is the object to provide a leakage diagnosis system for a tank of a vehicle which is less susceptible to contamination and wear, which can also bring larger tanks to a desired pressure in a shorter time and which has enhanced safety, and to provide a method for a leakage diagnosis for a tank of a vehicle having this improved leakage diagnosis system.

This is achieved by a leakage diagnosis system which comprises at least one first connection point and a second connection point, a diaphragm pump, a ventilation valve, an evaluation unit and a safety valve. The first connection point and the second connection point are each designed to be connected to a tank, for example a fuel tank, of a vehicle or to be open to the environment. Thus a tank can be connected to one of the two connection points, and the other connection point, to which the tank is not connected, can be open to the environment. The diaphragm pump is connected between the first connection point and the second connection point and is designed for pumping fluid from the first connection point to the second connection point. Thus the diaphragm pump is designed to generate a negative pressure in a tank which is connected to the first connection point, by pumping the fluid from the first connection point to the second connection point, or to generate a positive pressure in a tank which is connected to the second connection point. Due to its design principle, a diaphragm pump has fewer wear parts than a vane pump and at the same time is less sensitive to contamination, resulting in slower ageing. Diaphragm pumps also have a higher pumping capacity which enables larger tanks to be brought to a desired pressure in a shorter time than is possible by using a vane pump. The ventilation valve is connected parallel to the diaphragm pump between the first connection point and the second connection point and has at least one first position and at least one second position. In the first position of the ventilation valve, the first connection point and the second connection point are fluidically connected together, so that fluids can flow in both directions between the first connection point and the second connection point through the ventilation valve. In the second position of the ventilation valve, at least one fluid flow from the second connection point to the first connection point is prevented through the ventilation valve. In particular, a fluid flow between the first connection point and the second connection point is entirely prevented through the ventilation valve in the second position. The ventilation valve is designed such that it can be switched between the first position and the second position, so that it is possible to switch between a free fluid flow between the first connection point and the second connection point in both directions via the ventilation valve and a prevention of the fluid flow at least from the second connection point to the first connection point through the ventilation valve. The leakage diagnosis system is able to be used as a tank ventilation of the tank. As a result, the ventilation can be ensured at any time and, in particular, interrupted only during the leakage diagnosis. The evaluation unit is designed to operate the diaphragm pump and thus to permit a fluid flow from the first connection point to the second connection point by the diaphragm pump. The evaluation unit is also designed to switch the ventilation valve from its first position into its second position and thus to prevent the fluid flow at least from the second connection point to the first connection point through the ventilation valve. As a result, a fluid flow can take place only from the first connection point to the second connection point through the ventilation valve. The evaluation unit is also designed to determine a pressure, in particular a pressure curve, of a tank which is connected to the first connection point or the second connection point and to deduce the existence of a leakage in the connected tank from the determined pressure, in particular from the determined pressure curve. The tank can be brought to the desired pressure by the supply of fluid by operating the diaphragm pump. Due to the pressure difference between the pressure in the tank and the pressure of the environment, a fluid flow is present between the tank and the environment when a leakage is present. The existence of a leakage in the tank can be deduced from the resulting chronological change in pressure in the tank. This time-pressure curve in the tank can be compared, for example, with previously experimentally determined and stored time-pressure curves of the tank in the case of different sizes of leakages of the tank in order to deduce a size of the leakage in the tank.

The safety valve is designed to at least partially reduce a pressure difference between the first connection point and the second connection point. Thus in the case of excessive positive pressure at the second connection point the safety valve can compensate for this positive pressure, whereby damage to the components of the leakage diagnosis system can be prevented.

The safety valve is connected, for example, at its first end to the second connection point and at its second end is open to the environment. As a result, the safety valve can balance an excessive positive pressure at the second connection point, in particular in the tank, directly with an ambient pressure (atmospheric pressure). Alternatively, the safety valve can be connected at its first end to the first connection point and at its second end it can be open to the environment. As a result, in the event that the first connection point is connected to the tank, the safety valve can balance an excessive negative pressure at the first connection point, in particular in the tank, directly with the ambient pressure.

The safety valve is connected to the first connection point and to the second connection point, parallel to the diaphragm pump and/or parallel to the ventilation valve. As a result, in the presence of too great a pressure difference between the first connection point and the second connection point the safety valve can permit a fluidic connection between the first connection point and the second connection point in order to compensate for the aforementioned pressure difference.

The safety valve is designed to open at a first predetermined pressure difference as the opening pressure and to close at a second predetermined pressure difference as the closing pressure. The opening pressure and the closing pressure are different from one another.

It is advantageous, in particular, if the closing pressure is lower than the opening pressure. As a result, in particular, the safety valve is prevented from continually opening and closing.

In a further embodiment, the safety valve in particular is a spring-loaded check valve. As a result, the safety valve can be produced in a cost-effective and simple manner and a compact overall size of the leakage diagnosis system can be provided.

In an embodiment, the leakage diagnosis system comprises at least one first pump valve and at least one second pump valve. The first pump valve is connected in series to the diaphragm pump between the first connection point and the diaphragm pump and the second pump valve is connected in series to the diaphragm pump between the diaphragm pump and the second connection point. The first pump valve is designed such that a fluidic connection is present between the first connection point and the diaphragm pump during a suction process of the diaphragm pump, and no fluidic connection is present from the diaphragm pump to the first connection point during a compression process of the diaphragm pump. The second pump valve is designed such that no fluidic connection is present between the second connection point and the diaphragm pump during a suction process of the diaphragm pump and a fluidic connection is present between the diaphragm pump and the second connection point during a compression process of the diaphragm pump. As a result, the leakage diagnosis system is designed such that during a suction process of the diaphragm pump fluids flow into the diaphragm pump from the first connection point and not from the second connection point and due to a compression process fluids flow from the diaphragm pump to the second connection point and not to the first connection point. Thus the leakage diagnosis system is designed in a tank which is connected to the first connection point to increase a negative pressure in the connected tank with each suction process of the diaphragm pump and in a tank which is connected to the second connecting point to increase a positive pressure in the connected tank with each compression process of the diaphragm pump. This embodiment also prevents a fluidic connection between the second connection point and the first connection point through the diaphragm pump.

In a further embodiment of the leakage diagnosis system, the first pump valve and the second pump valve are check valves, in particular umbrella valves. The first check valve and the second check valve are oriented in the same direction and permit a fluid flow from the first connection point to the diaphragm pump and from the diaphragm pump to the second connection point, so that a free fluid flow is not present between the second connection point and the first connection point via the diaphragm pump. Thus the leakage diagnosis system is designed to pump fluids in only one direction through the diaphragm pump from the first connection point to the second connection point. The leakage diagnosis system is designed to prevent a free fluid flow from the second connection point to the first connection point through the diaphragm pump. The first pump valve and the second pump valve are connected in each case to both sides of a diaphragm of the diaphragm pump, in order to permit a continuous pumping of fluid through the diaphragm pump.

In a further embodiment of the leakage diagnosis system, the ventilation valve is held in its first position by a resilient restoring force of a spring and can be transferred into its second position by an electromagnet. The ventilation valve is designed such that, when energized, the electromagnet can act against the resilient restoring force of the spring and can transfer the ventilation valve from the first position into the second position and hold it in the second position. Without being energized, the electromagnet cannot act against the restoring force of the spring so that the spring transfers the ventilation valve from the first position into the second position. The electromagnet can be designed such that it can be activated by the evaluation unit. In particular, the electromagnet can be designed such that it can be energized during the operation of the diaphragm pump and the duration of the leakage diagnosis and closes the ventilation valve, so that over the duration of the leakage diagnosis no pressure compensation can take place between the second connection point and the first connection point via the ventilation valve. If no leakage diagnosis takes place, the ventilation valve is held open by the restoring force of the spring. Since no activation or energizing is required for this first position of the ventilation valve, a ventilation of the tank is ensured at all times.

In a further embodiment, the leakage diagnosis system comprises an electric motor, an eccentric and a connecting rod. The eccentric is connected to the electric motor and one end of the connecting rod is connected to the eccentric. The diaphragm of the diaphragm pump is connected at the other end of the connecting rod which is not connected to the eccentric. These elements of the leakage diagnosis system are designed such that the operation of the electric motor brings about a lifting movement of the diaphragm of the diaphragm pump. This lifting movement of the diaphragm of the diaphragm pump leads to a suction process or a compression process and thus to a positive pressure or a negative pressure in a tank which is connected to the first connection point or second connection point.

The leakage diagnosis system has at least one pressure sensor which is fluidically connected to the first connection point or the second connection point. As a result, the pressure sensor is designed to measure a pressure of a tank which is connected to the first connection point or to the second connection point. The pressure sensor is connected to the evaluation unit. Thus the pressure, in particular the pressure curve, in the tank can be easily detected by the evaluation unit. In particular, the at least one pressure sensor between the diaphragm pump and the first connection point or the second connection point is fluidically connected to the first connection point or the second connection point. A design of the leakage diagnosis system which is as compact as possible can be made possible thereby.

The leakage diagnosis system has at least a first pressure sensor and a second pressure sensor. The first pressure sensor is fluidically connected to the first connection point and the second pressure sensor is fluidically connected to the second connection point, in order to detect the pressure of a tank which is connected to the first connection point or second connection point and to detect a pressure in the environment. This permits a simple determination of a positive pressure or negative pressure in the tank relative to the environment by the evaluation unit. This also permits both the determination of the existence of a leakage in the tank and the determination of the size of a leakage by the evaluation unit. For example, after a desired pressure has been set in the tank, the further time-pressure curve in the tank can be detected by the pressure sensor and compared by the evaluation unit with stored time-pressure curves, by taking into account the pressure of the environment. As a result, a particularly efficient and accurate leakage diagnosis is provided.

In an embodiment, the evaluation unit is designed to detect electrical signals of the safety valve which signal an opening and closing of the safety valve. In other words, the safety valve outputs to the evaluation unit electrical signals which signal a closed and/or at least partially open state of the safety valve. The evaluation unit can be designed, in particular, to switch off the diaphragm pump in response to these electrical signals, for example. Alternatively or additionally, the evaluation unit can store the pressure determined (by the current consumption of the diaphragm pump) or detected (by pressure sensor(s)) at the first connection point at the time of opening the safety valve. This stored value can then be compared by the evaluation unit with a stored opening pressure of the safety valve, for example in order to carry out an error analysis of the leakage diagnosis system.

The evaluation unit is designed to detect electrical signals, in particular a current consumption, of the diaphragm pump and to determine by the detected electrical signals the pressure, in particular the pressure curve, in a tank which is connected to the first connection point or the second connection point. This makes it possible, for example, to determine a pressure, in particular a pressure curve, of a tank which is connected to the first connection point or second connection point, without a pressure sensor being required. This enables the material costs and the assembly costs for a pressure sensor to be saved. The possible absence of a pressure sensor also permits a more compact design of the leakage diagnosis system.

The pressure, in particular the pressure curve, is determined from a current value drawn or consumed by the pump and/or a power consumed at a known rated voltage of the diaphragm pump or the time curves thereof. If the fluid pumping capacity of the diaphragm pump is known, therefore, the prevailing pressure can be determined from the determined power of the diaphragm pump.

Alternatively a table can be stored with experimentally determined current values, in particular current curves, at different pressures, in particular pressure curves, of a tank which is connected to the first connection point or second connection point. By comparing the current value determined by the evaluation unit, in particular a current curve, with such a stored table, the pressure, in particular the pressure curve, of the fluid can be determined in a tank which is connected to the first or the second connection point.

The system is further achieved by a method for leakage diagnosis for a tank, in particular a fuel tank, of a vehicle by means of a leakage diagnosis system. The leakage diagnosis system comprises at least one first connection point and a second connection point, a diaphragm pump and a ventilation valve. The first connection point and the second connection point are designed to be connected to a tank or to be open to the environment. The diaphragm pump is arranged between the first connection point and the second connection point, is fluidically connected to both connection points and is designed for pumping fluid between the first connection point and the second connection point. The ventilation valve is connected parallel to the diaphragm pump between the first connection point and the second connection point and is designed to be switched between a first position and a second position. In the first position, the ventilation valve permits a fluidic connection between the first connection point and the second connection point. As a result, a fluid flow is possible in both directions through the ventilation valve. In the second position, the ventilation valve prevents a fluid flow between the second connection point and the first connection point. The method for leakage diagnosis is carried out as follows. In a first method step, the ventilation valve is switched into the second position. As a result, a fluid flow from the second connection point to the first connection point is prevented through the ventilation valve. In a second method step, the diaphragm pump is operated in order to generate a positive pressure or a negative pressure in a tank which is connected to the first connection point or second connection point. In a third method step, a pressure, in particular a pressure curve, is determined in the connected tank in order to deduce the existence of a leakage in the tank.

The invention further relates to a vehicle which has a tank and the leakage diagnosis system according to the previous preferred embodiments, wherein the tank is fluidically connected to the first connection point or the second connection point of the leakage diagnosis system.

The vehicle can be, in particular, a motor vehicle.

The evaluation unit can have or be, in particular, a processor such as a CPU/GPU/FPGA. In particular, the evaluation unit can be an engine control unit of the vehicle. Alternatively or additionally, the evaluation unit can have a transceiver, commands for an operation and/or determined results of the evaluation unit being able to be wirelessly transmitted thereby.

The leakage diagnosis system of all of the above preferred embodiments is designed to carry out the aforementioned method, in particular by the evaluation unit.

Further areas of applicability will become apparent from the description provided herein. The description and specific examples in this summary are intended for purposes of illustration only and are not intended to limit the scope of the present disclosure.

### DRAWINGS

Further details, advantages and features of the present invention are found in the following description of exemplary embodiments with reference to the drawing, in which:

FIG. 1 shows a sketch of a vehicle with a leakage diagnosis system according to an embodiment of the present invention;

FIG. 2 shows a sketch of the leakage diagnosis system according to the embodiment of the present invention;

FIG. 3 shows a sketch for explaining an exemplary construction of a diaphragm pump of the leakage diagnosis system according to the embodiment of the present invention; and

FIG. 4 shows a block diagram of a method for a leakage diagnosis according to an embodiment of the present invention.

Corresponding reference numerals indicate corresponding parts throughout the several views of the drawings.

### DETAILED DESCRIPTION

Example embodiments will now be described more fully with reference to the accompanying drawings.

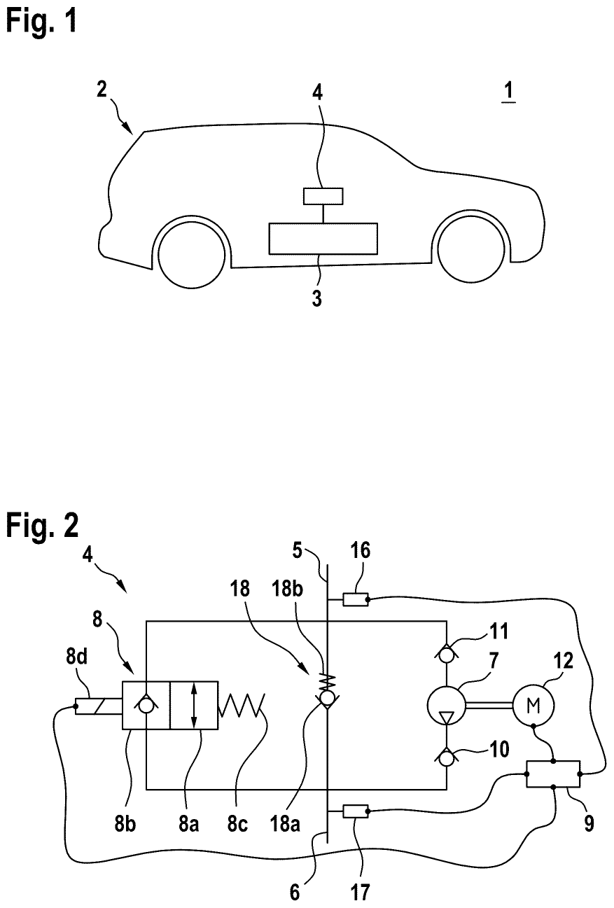

FIG. 1 shows a sketch of a vehicle 2 with a tank 3 for fuel and a leakage diagnosis system 4 according to an embodiment. The reference sign 1 indicates an environment 1, wherein the environment 1 is air (atmosphere).

The leakage diagnosis system 4 can be installed fixedly in the vehicle 2. Alternatively, the leakage diagnosis system 4 can be non-destructively removable from the vehicle 2, wherein one or more connections to the tank 3 are also non-destructively releasable.

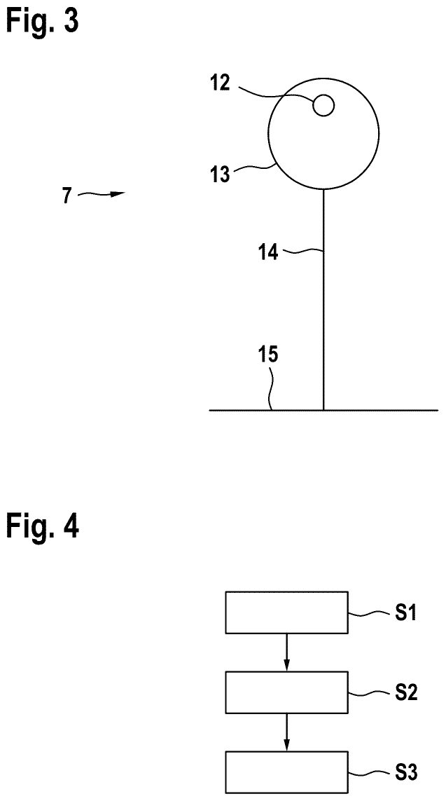

Initially an exemplary construction and the mode of operation of the leakage diagnosis system 4 is explained by way of FIGS. 2 and 3. The method for the leakage diagnosis is explained by way of FIG. 4.

FIG. 2 shows a sketch of the leakage diagnosis system 4 according to the embodiment of the present invention.

The leakage diagnosis system 4 comprises a first connection point 5 and a second connection point 6, as well as a diaphragm pump 7. The diaphragm pump 7 is designed for pumping fluid from the first connection point 5 to the second connection point 6.

The first connection point 5 and the second connection point 6 are each designed to be connected to the tank 3 or to be open to the environment 1 (atmospheric air). Which connection point 5, 6 is connected to the tank 3 depends on whether the leakage diagnosis is carried out by a negative pressure or a positive pressure in the tank 3. If the second connection point 6 is connected to the tank 3, the pumping of fluid by the diaphragm pump 7 produces a positive pressure in the tank 3. If, on the other hand, the first connection point 5 is connected to the tank 3, the pumping of fluid by the diaphragm pump 7 brings about a negative pressure in the tank 3.

The diaphragm pump 7 has an electric motor 12 or can be driven by an electric motor 12. Moreover, a first pump valve 10 and a second pump valve 11 are provided. The first pump valve 10 and the second pump valve 11 are arranged in series with and between the first connection point 5 and the second connection point 6 and designed as check valves. Thus the pump valves 10, 11 cause the fluid flow of the diaphragm pump 7 to take place in a predetermined direction as follows.

During a suction process of the diaphragm pump 7, a fluidic connection is present between the diaphragm pump 7 and the first connection point 5 but not between the diaphragm pump 7 and the second connection point 6. In a compression process of the diaphragm pump 7, a fluidic connection is present between the diaphragm pump 7 and the second connection point 6 but not between the diaphragm pump 7 and the first connection point 5. As a result, a pumping of fluid from the first connection point 5 to the second connection point 6 by the diaphragm pump 7 is generated via the pump valves 10, 11.

FIG. 3 shows a sketch for explaining further details of an exemplary construction of the diaphragm pump 7 of the leakage diagnosis system 4 according to the embodiment.

The electric motor 12 is connected to an eccentric 13. The eccentric 13 in turn is connected to a connecting rod 14. A rotational force of the electric motor 12 is converted by the eccentric 13 into a linear force which is transmitted by the connecting rod 14 to a diaphragm 15 of the diaphragm pump 7. This brings about a rotation of the electric motor 12, more specifically a shaft of the electric motor 12, not shown, a lifting movement of the diaphragm 15 and thus a compression process or a suction process of the diaphragm pump 7. In principle, a lifting movement of the diaphragm 15 brought about by the electromagnet 8d leads to a positive pressure (compression process) or to a negative pressure (suction process).

The leakage diagnosis system 4 as shown in FIG. 2 also comprises a ventilation valve 8. The ventilation valve 8 is connected parallel to the diaphragm pump 7 between the first connection point 5 and the second connection point 6 and has two positions 8a, 8b.

In the first position 8a the ventilation valve 8 is open so that the first connection point 5 and the second connection point 6 are fluidically connected to one another. As a result, fluids, in particular air, can flow in both directions between the first connection point 5 and the second connection point 6 through the ventilation valve 8. In the second position 8b the ventilation valve 8 is closed, so that a fluid flow from the second connection point 6 to the first connection point 5 is prevented through the ventilation valve 8. The ventilation valve 8 is switchable continuously, in particular between both positions, so that fluid flows can also be partially prevented, i.e. throttled.

To this end, the ventilation valve 8 has an electromagnet 8d and a spring 8c. The spring 8c is designed and arranged such that it acts against a force which can be generated by the electromagnet 8d. In other words, a sufficiently high force generated by the electromagnet 8d compresses the spring 8c, whereby the ventilation valve 8 can be switched between the two positions 8a, 8b. In a non-energized state of the electromagnet 8d, the ventilation valve 8 is in the first position 8a. FIG. 2 shows an energized state of the electromagnet 8d and thus the ventilation valve 8 in the second position 8b.

As the electromagnet 8d overcomes the spring force of the spring 8c only by being energized, and as a result can switch the ventilation valve 8 to the second position 8b, it is ensured that in the case of a malfunction of the ventilation valve 8 it remains in the first position 8a so that a ventilation of the tank 3 can be ensured.

The leakage diagnosis system 4 also comprises an evaluation unit 9. The evaluation unit 9 is connected to an electric motor 12 of the diaphragm pump 7 and to the electromagnet 8d of the ventilation valve 8. The evaluation unit 9 is designed to control the diaphragm pump 7 by the electric motor 12 and the ventilation valve 8 by the electromagnet 8d.

The evaluation unit 9 is also connected to a first pressure sensor 16 which detects a pressure at the first connection point 5 and to a second pressure sensor 17 which detects a pressure at the second connection point 6.

Alternatively or additionally to one or both pressure sensors 16, 17, the evaluation unit 9 can determine the pressure from electrical signals, in particular from a current consumption of the diaphragm pump 7. In particular at a given rated voltage, the current consumption is correlated with a power of the diaphragm pump 7 from which a pressure generated by the diaphragm pump 7 can be determined.

The leakage diagnosis system 4 also comprises a safety valve 18. The safety valve 18, which for example is a spring-loaded check valve, is connected—parallel to the diaphragm pump 7 and to the ventilation valve 8—to the first connection point 5 and to the second connection point 6. As a result, a possible excessive positive pressure or negative pressure in the tank 3 is balanced with an ambient pressure (atmospheric pressure) by opening the safety valve 18.

An opening pressure is defined as a pressure difference between the first connection point 5 and the second connection point 6 which leads to the opening of the safety valve 18. A closing pressure is defined as a pressure difference between the first connection point 5 and the second connection point 6 which leads to the closing of the safety valve 18. The opening pressure and the closing pressure are different from one another.

An effective surface of a sealing element 18a of the safety valve 18 is designed such that the closing pressure is lower than the opening pressure. This is achieved, for example, by a conical sealing element 18a. A pressure of the fluid acts on the sealing element 18a in order to lift it from a valve seat (not shown) when the opening pressure is reached. The opening pressure—and thus the closing pressure—are set by a spring force of a return spring 18b. As soon as the sealing element 18a is lifted from the valve seat, the effective surface increases so that a force acting due to the fluid pressure on the return spring 18b of the safety valve 18 increases. As a result, the closing pressure, i.e. the pressure difference at which the safety valve 18 closes again, is below the opening pressure.

As the closing pressure of the safety valve 18 is below the opening pressure of the safety valve 18, a continuous opening and closing of the safety valve 18 can be prevented should a source of error, which has led to an excessive positive pressure/negative pressure, not have been eliminated. The further the difference pressure between the first connection point 5 and the second connection point 6, which is used for the leakage diagnosis, lies below an admissible pressure for the tank 3, the better the tank 3 and the leakage diagnosis system 4 are protected from overload.

When the safety valve 18 is opened, the first connection point 5 and the second connection point 6 are fluidically connected to one another.

The safety valve 18 can also be connected to the evaluation unit 9, wherein the evaluation unit 9 can receive and process times, or time periods, of the opening and/or closing of the safety valve 18. For example, a previously known opening pressure of the safety valve 18 can be compared with a pressure in the tank 3 which has been detected or determined at the time of opening of the safety valve 18, in order to determine a possible malfunction of the diaphragm pump 7 and/or a pressure sensor 16, 17.

An operation of the leakage diagnosis system 4 for the leakage diagnosis is explained hereinafter by way of FIG. 4. FIG. 4 shows a block diagram of a method for a leakage diagnosis according to an embodiment of the present invention.

In a first method step S1 the ventilation valve 8 is switched into the second position 8b. A fluid flow through the ventilation valve 8 from the second connection point 6 to the first connection point 5 is prevented thereby.

In a second method step S2 the diaphragm pump 7 is operated in order to generate a positive pressure or a negative pressure in a tank 3 which is connected to the first connection point 5 or to the second connection point 6. As already explained, the diaphragm pump 7 pumps fluid from the first connection point 5 to the second connection point 6.

In a third method step S3 a pressure, in particular a pressure curve, in the connected tank 3 is determined in order to deduce the existence of a leakage in the tank 3. As explained above, the pressure can be detected by the pressure sensors 16, 17 and/or by the electrical signals of the diaphragm pump 7.

The diaphragm pump 7 can be switched off, in particular, between the steps S2 and S3, since the pump valves 10, 11 and the closed ventilation valve 8 prevent a pressure compensation between the first connection point 5 and the second connection point 6. If in the meantime a falling pressure (positive pressure in the tank 3 brought about by the diaphragm pump 7) is detected by the pressure sensors 16, 17, a leakage in the tank 3 can be deduced by this detection. To this end, for example, a time-pressure curve of the pressure can be recorded by the pressure sensors 16, 17 and evaluated by the evaluation unit 9.

Alternatively, a single pressure detection can take place. It is assumed here that the diaphragm pump 7 has produced a predetermined pressure in the tank 3 (after a predetermined pumping time). Then after a predetermined waiting time the pressure in the tank 3 can be detected by at least one of the pressure sensors 16, 17. If the detected pressure deviates from the predetermined pressure produced by the diaphragm pump 7, a leakage in the tank 3 can be deduced. The deviation between the detected and the anticipated pressure can be compared, in particular, with experimentally determined values in order to deduce the existence and a size of the leakage. For example, it can be determined that a leakage is present only when the deviation is above a predetermined threshold in a predetermined time period, in order to take into account, for example, error tolerances or untightness in the leakage diagnosis system 4.

When using the electrical signals of the diaphragm pump 7 for determining the pressure generated by the diaphragm pump 7, for example, the diaphragm pump 7 can be operated constantly between the steps S2, S3. If a leakage is present in the tank 3, the current consumption of the diaphragm pump 7 increases to generate the predetermined pressure. In turn an anticipated current consumption of the diaphragm pump 7 can be compared with a reference value which can be determined experimentally, so that the existence of a leakage can be deduced. A size of the leakage can also be deduced by a determined fluid pumping capacity of the diaphragm pump 7.

The aforementioned steps S1-S3 are carried out, in particular, by the evaluation unit 9. To this end, the evaluation unit 9 can have or be a CPU/GPU/FPGA. Alternatively or additionally, an engine control unit (not shown) of the vehicle 2 can be designed as the aforementioned evaluation unit 9.

In addition to the above written description of the invention, reference is made explicitly to the graphical representation of the invention in FIGS. 1 to 4 for the additional disclosure thereof.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

### LIST OF REFERENCE SIGNS

1 Environment
2 Vehicle
3 Tank
4 Leakage diagnosis system
5 First connection point
6 Second connection point
7 Diaphragm pump
8 Ventilation valve
8a First position
8b Second position
8c Spring
8d Electromagnet
9 Evaluation unit
10 First pump valve
11 Second pump valve
12 Electric motor
13 Eccentric
14 Connecting rod
15 Diaphragm
16 First pressure sensor
17 Second pressure sensor
18 Safety valve
18a Sealing element
18b Return spring
S1 First step
S2 Second step
S3 Third step

1-10. (canceled)

11. A leakage diagnosis system for a tank of a vehicle, comprising:
at least one first connection point and a second connection point which are each configured to be connected to the tank or to be open to an environment:
at least one diaphragm pump configured to pump fluid from the first connection point to the second connection point;
at least one ventilation valve which is connected parallel to the diaphragm pump between the first connection point and the second connection point and configured to be switched into a first position in which the first connection point and the second connection point are fluidically connected, and into a second position which prevents a fluid flow at least from the second connection point to the first connection point;
at least one evaluation unit configured to operate the diaphragm pump, to switch the ventilation valve into the second position and to determine a pressure, including a pressure curve, in a tank which is connected to the first connection point or second connection point, in order to deduce the existence of a leakage in the tank from the pressure, including the pressure curve; and
at least one safety valve configured to at least partially reduce a pressure difference between the first connection point and the second connection point;
wherein the at least one evaluation unit is designed to detect electrical signals of the safety valve which signal an opening and closing of the safety valve.

12. The leakage diagnosis system as claimed in claim 11, wherein the safety valve is connected to the first connection point and the second connection point, parallel to the diaphragm pump and/or to the ventilation valve.

13. The leakage diagnosis system as claimed in claim 11, wherein the safety valve is configured to open at a first predetermined pressure difference as the opening pressure, and to close at a second predetermined pressure difference as the closing pressure, wherein the opening pressure and the closing pressure are different from one another.

14. The leakage diagnosis system as claimed in claim 13, wherein the closing pressure is lower than the opening pressure.

15. The leakage diagnosis system as claimed in claim 11, wherein the safety valve is a spring-loaded check valve.

16. The leakage diagnosis system as claimed in claim 11, wherein at least one pressure sensor is fluidically connected to the first connection point or the second connection point in order to measure a pressure in a tank which is connected to the first connection point or the second connection point.

17. The leakage diagnosis system as claimed in claim 11, wherein the at least one evaluation unit is configured to detect electrical signals, including a current consumption, of the diaphragm pump and to determine by the electrical signals the pressure, including the pressure curve, in a tank which is connected to the first connection point or second connection point.

18. A motor vehicle comprising a tank and the leakage diagnosis system as claimed in claim 11, wherein the tank is fluidically connected to the first connection point or the second connection point of the leakage diagnosis system.

19. A method for a leakage diagnosis for a tank of a vehicle by a leakage diagnosis system comprising at least one first connection point and a second connection point which are each configured to be connected to the tank or to be open to an environment, at least one diaphragm pump configured to pump fluid from the first connection point to the second connection point, at least one ventilation valve connected parallel to the diaphragm pump between the first connection point and the second connection point and configured to be switched in a first position in which the first connection point and the second connection point are fluidically connected, and a second position which prevents a fluid flow at least from the second connection point to the first connection point, and at least one safety valve configured to at least partially reduce a pressure difference between the first connection point and the second connection point, wherein at least one evaluation unit is configured to detect electrical signals of the safety valve which signal an opening and closing of the safety valve, wherein the method comprises:
a first step in which the ventilation valve is switched into the second position;
a second step in which the diaphragm pump is operated in order to generate a positive pressure or a negative pressure in a tank which is connected to the first connection point or second connection point; and
a third step in which the evaluation unit determines a pressure, in including pressure curve, in the tank in order to deduce the existence of a leakage in the connected tank.
